(19) United States
(12) Patent Application Publication
(10) Pub. No.: US 2016/0156709 A1
(43) Pub. Date: Jun. 2, 2016

(54) SYSTEM AND METHOD FOR DETECTING SMALL GROUP AND OUTCAST

(71) Applicant: Electronics and Telecommunications Research Institute, Daejeon-city (KR)

(72) Inventors: Jang-Ho CHOI, Incheon (KR); Dong-Oh KANG, Daejeon (KR); Chang-Seok BAE, Daejeon (KR); Joon-Young JUNG, Daejeon (KR)

(21) Appl. No.: 14/591,400

(22) Filed: Jan. 7, 2015

(30) Foreign Application Priority Data
Dec. 2, 2014 (KR) 10-2014-0170317

(51) Int. Cl. H04L 29/08

(52) U.S. Cl. CPC H04L 67/1044; H04L 67/18; H04L 67/22; H04L 67/24; H04L 67/306

(57) ABSTRACT

Disclosed herein is a system and method that analyze a plurality of types of interactions between devices and between users, predict intimacies therebetween, find small groups within a certain group based on the intimacies, and then detect outcasts. The system for detecting a small group and an outcast includes a data collection unit for collecting data based on interactions between objects. A data analysis unit analyzes the data. An intimacy prediction unit calculates intimacies between objects based on the analyzed data. A small group configuration unit detects one or more small groups from a certain group, based on the calculated intimacies. An outcast detection unit detects an outcast, based on presence or absence of each object in the one or more small groups and the intimacies.

### CROSS REFERENCE TO RELATED APPLICATION

This application claims priority to and the benefit of Korean Patent Application No. 10-2014-0170317, filed Dec. 2, 2014, which is hereby incorporated by reference in its entirety into this application.

### BACKGROUND OF THE INVENTION

1. Technical Field

The present invention relates generally to a system and method for detecting a small group and an outcast and, more particularly, to a system and method that predict intimacies by analyzing interactions between objects, and detect small groups and outcast objects present within a certain group based on the predicted intimacies.

2. Description of the Related Art

Methods of detecting an outcast object within a certain group are generally implemented using methods of configuring small groups in a certain group and finding an object that is not affiliated with the small groups.

Existing methods of configuring small groups are disclosed in U.S. Patent Application Publication No. 2014-0149509 (entitled “System and Method for Perceiving Outcast in Group”) and Korean Patent Application Publication No. 2009-0132753 (entitled “Terminal Equipment for Ward, Terminal Equipment for Guardian and Wireless System for Preventing Child from Going Missing by using the same”). As disclosed in the above patents, distances between objects are obtained using a wireless device, such as a user's smart phone, and small groups are configured based on the distances between the objects.

However, such a method of configuring small groups using distances chiefly has the following two constraints.

First, there is a difficulty in measuring precise distances. In outdoor areas, when a Global Positioning System (GPS) sensor is used together with a mobile phone base station, a Wi-Fi network, etc., the location of each user may be measured within an error range of 50 cm, thus enabling a distance to the location of the user to be precisely measured. However, it is impossible to measure location in indoor areas using a GPS sensor, so a distance between users indoors is chiefly measured using Bluetooth or Wi-Fi radio waves. However, since the variation in radio waves is not uniform, errors are relatively large. Further, there is a disadvantage in that when a distance between users is great (that is, when users are out of the range of Wi-Fi and Bluetooth), it is impossible to measure distance.

Second, there is a constraint in distance itself. Even if a user stays near a certain group, it is difficult to conclude that the user is not an outcast. For example, in the case of a class in a school, students in the same class may be classified in terms of distance as a single group. However, among the students, outcast students may exist. Therefore, in order to find a small group that reflects the real situation, small groups must be configured based on users' common interest and intimacy.

In the field of sociology, pieces of preceding research for predicting intimacies between users exist. For example, tie strength representing the intimacies of social ties between users was first introduced by Mark Granovetter. Tie strength is mainly predicted via dimensions such as time, intimacy, strength, mutual service exchanges, common structural factors, and social factors.

However, most preceding technologies analyze tie strength only within a limited range of communication data such as calls between persons and Short Message Service (SMS) message exchanges. Such data is only a part of the interactions between persons, and thus it is difficult to precisely predict intimacies.

### SUMMARY OF THE INVENTION

Accordingly, the present invention has been made keeping in mind the above problems occurring in the prior art, and an object of the present invention is to provide a system and method that analyze a plurality of types of interactions (emails, calls, content exchanges, etc.) between devices and between users, predict intimacies therebetween, find small groups within a certain group based on the intimacies, and then detect excluded objects (outcasts).

In accordance with an aspect of the present invention to accomplish the above object, there is provided a system for detecting a small group and an outcast, including a data collection unit for collecting data based on interactions between objects; a data analysis unit for analyzing the data; an intimacy prediction unit for calculating intimacies between objects based on the analyzed data; a small group configuration unit for detecting one or more small groups from a certain group, based on the calculated intimacies; and an outcast detection unit for detecting an outcast, based on presence or absence of each object in the one or more small groups and the intimacies.

The outcast detection unit may determine an object that is not affiliated with any small groups to be an outcast.

The outcast detection unit may be configured such that, even if an object is affiliated with at least one small group, when an intimacy of the object is less than an outcast determination threshold for the affiliated small group, the object is determined to be an outcast in the affiliated small group.

The outcast detection unit may be configured such that, when an object is affiliated with a plurality of small groups, but a sum of intimacies of the object in the plurality of small groups is less than an outcast determination threshold, the object is determined to be an outcast.

The intimacy prediction unit may calculate the intimacies between objects based on the analyzed data by utilizing a linear model in which, as more common grounds are present and a number of interactions is larger between objects, intimacies become higher.

The data analysis unit may analyze the data based on the interactions and then calculates weights.

The data based on the interactions may include communication data, shared content data, and explicit data.

The system may further include a user interface unit for displaying the objects and displaying performance results of the small group configuration unit and the outcast detection unit.

The user interface unit may represent the outcast by a blinking object or by a separate mark.

The user interface unit may determine distances between the objects depending on the intimacies calculated by the intimacy prediction unit, and displays the distances.

The user interface unit may be configured to, as an intimacy between the objects is higher, indicate a line connected to the objects by a bolder line.

In accordance with another aspect of the present invention to accomplish the above object, there is provided a method for detecting a small group and an outcast, including collecting, by a data collection unit, data based on interactions between objects; analyzing, by a data analysis unit, the data; calculating, by an intimacy prediction unit, intimacies between objects based on the analyzed data; detecting, by a small group configuration unit, one or more small groups from a certain group, based on the calculated intimacies; and detecting, by an outcast detection unit, an outcast based on presence or absence of each object in the one or more small groups and the intimacies.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example of a central management mode to which an embodiment of the present invention is applicable;

FIG. 2 is a diagram showing an example of a distributed management mode to which an embodiment of the present invention is applicable;

FIG. 3 is a configuration diagram showing a system for detecting a small group and an outcast according to an embodiment of the present invention; and

FIG. 4 is a flowchart showing a method for detecting a small group and an outcast according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

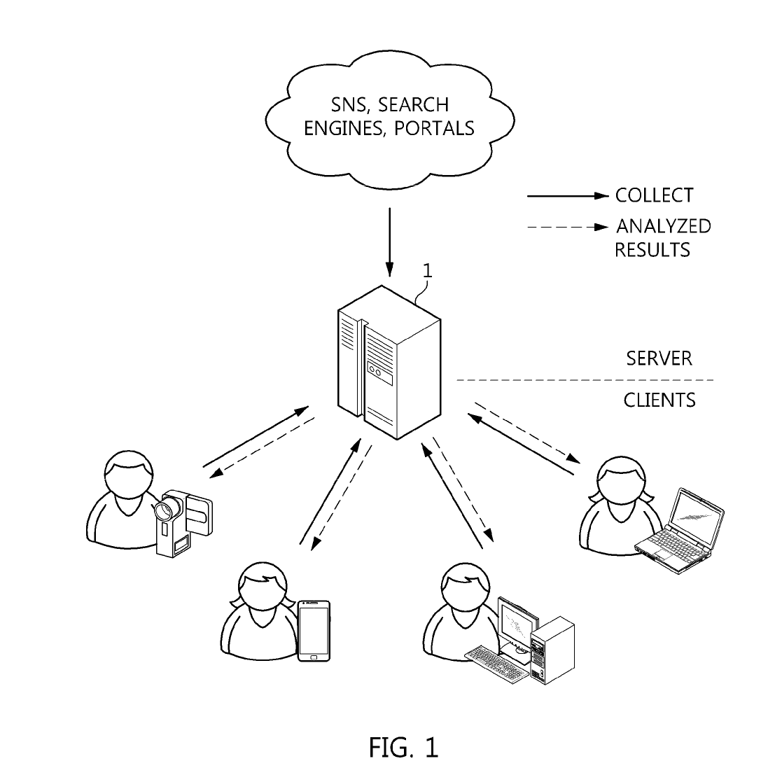

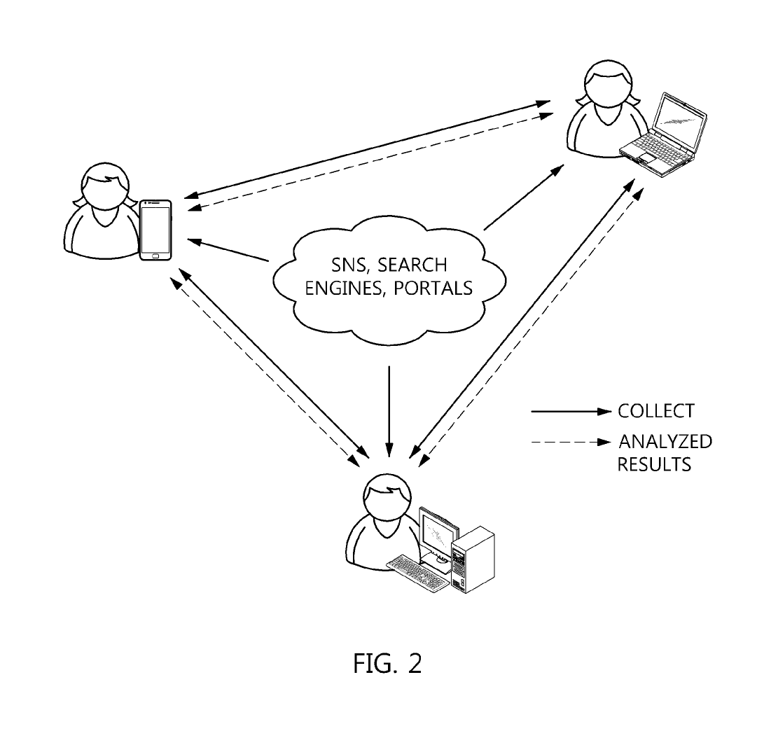

FIG. 1 is a diagram showing an example of a central management mode to which an embodiment of the present invention is applicable, and FIG. 2 is a diagram showing an example of a distributed management mode to which an embodiment of the present invention is applicable.

The present invention supports a central management mode in which monitoring and analysis are centrally managed by a server, and a distributed management mode in which devices individually monitor and analyze interactions, upon monitoring and analyzing interactions between objects.

In the central management mode of FIG. 1, the profile, Social Network Service (SNS) information, and context information of each user, and interactions between devices are collected, integrated and analyzed by a server 1.

In the distributed management mode of FIG. 2, context information and interactions directly collected from connected objects are analyzed and shared.

The embodiment of the present invention may continuously collect and share interactions between objects that are independently communicable, such as smart phones, tablets, notebooks, or desktop computers. In this case, the collected data may be stored in devices (that is, terminals possessed by persons) according to each person's intention and may be used to analyze intimacies. Here, examples of interactions include communication data (emails, calls, SMS messages, etc.), shared content data (transmitted/received pictures, videos, etc.), and explicit data (user information, affiliation, friend relationships, etc.). Further, such interaction data may be directly monitored and collected by each device, and may also be collected via portal sites, SNS sites, etc. to which each user has subscribed over the Internet. Examples of interaction data include profile information, affiliation, friend relationship, and news feed information of each user, collected via a Facebook Open Application Program Interface (API).

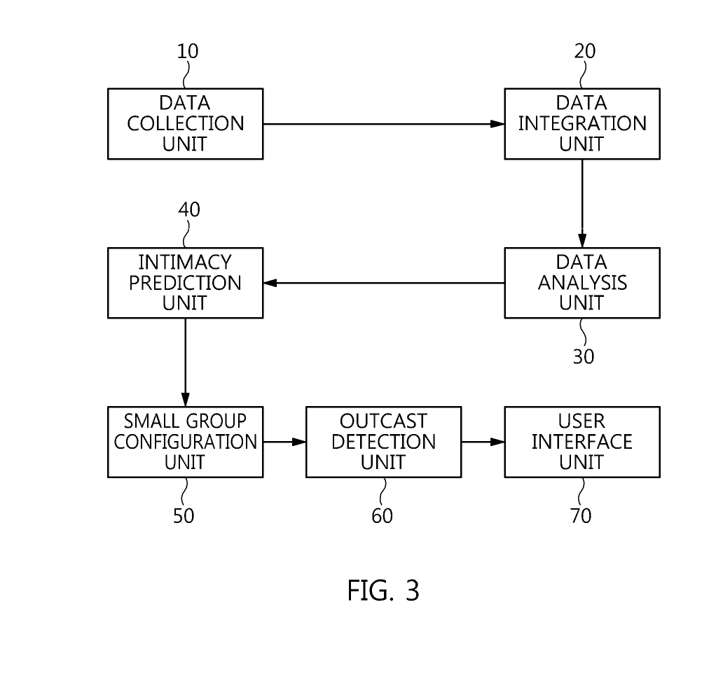

FIG. 3 is a configuration diagram showing a system for detecting a small group and an outcast according to the present invention. The system for detecting a small group and an outcast according to the embodiment of the present invention may be either the server of FIG. 1 or a terminal possessed by each object (e.g., person) of FIG. 2.

The system for detecting a small group and an outcast according to the present invention includes a data collection unit 10, a data integration unit 20, a data analysis unit 30, an intimacy prediction unit 40, a small group configuration unit 50, an outcast detection unit 60, and a user interface unit 70.

In order to calculate intimacies between individual objects, a device possessed by each object may record and share interactions with other devices. Upon recording interactions, the content of interactions may not be recorded to protect the user, and only the time at which each interaction occurs, the number of interactions, and the duration (or size) of each interaction may be recorded and shared depending on the situation (context). Here, each device may be either the server 1 of FIG. 1 or the terminal possessed by each object of FIG. 2.

Further, each device may collect explicit information, such as its own user information or the user information of other devices, from SNS sites or Internet Portal sites.

The data collection unit 10 may continuously collect interactions between communicable objects. In this way, data based on interactions between objects may be regarded as “interaction data”. For example, interaction data includes communication data (emails, calls, SMS messages, etc.), shared content data (transmitted/received pictures, videos, etc.), and explicit data (user information [object information: name, age, etc.], affiliation, friend relationship, etc.).

The data collection unit 10 is configured not only to directly monitor and collect the interaction data from the corresponding device, but also to collect the interaction data from portal sites or SNS sites to which the user has subscribed over the Internet.

The data integration unit 20 integrates the data collected by the data collection unit 10 and eliminates duplicated data.

That is, the data integration unit 20 may collect data from other objects and integrate the collected data. For example, the data integration unit 20 may receive collected data and analyzed data in the distributed management mode from other objects and integrate the received data with its own data.

In FIG. 3, although the data collection unit 10 and the data integration unit 20 have been configured as separate components, they may be integrated into a single unit as necessary.

The data analysis unit 30 analyzes the data integrated by the data integration unit 20, calculates weights depending on the densities of interactions, and standardizes the data if necessary. Here, for the interactions, the semantic information of interactions may also be analyzed together with the direction, the number, and strengths of interactions. Along with this, interactions may be separated depending on the type or semantic information of the interactions so that only specific interactions may be limitedly analyzed to predict intimacies. For example, only interactions occurring in a specific service may be separated and used to analyze the intimacy of a group that uses the specific service or, alternatively, only interactions occurring in a class may be separated and analyzed and then used to find a small group and an outcast object in the class.

The intimacy prediction unit 40 calculates intimacies between objects using an intimacy model, based on the data analyzed by the data analysis unit 30. For example, a linear model in which, as more common grounds are present and the number of interactions is larger between objects, intimacies become higher may be applied to the intimacy prediction unit.

The small group configuration unit 50 detects one or more small groups from the certain group, based on the intimacies calculated by the intimacy prediction unit 40. For example, as an intimacy between objects is higher, the objects may be configured as the same small group. Depending on a configuration scheme, each object may be affiliated with one or more small groups.

The outcast detection unit 60 detects an excluded object (outcast), based on the presence or absence of any object in one or more small groups and the intimacies of objects. For example, the outcast detection unit 60 determines an object, which is not affiliated with any small groups or an object whose intimacy is less than a threshold, to be an outcast. In other words, the object that is not affiliated with any small groups may be determined to be an excluded object (outcast). Meanwhile, even if there is a small group with which an object is affiliated, when the intimacy of the object is less than an outcast determination threshold for the affiliated small group, the object may be defined as an outcast in the affiliated small group. Meanwhile, when an object is affiliated with a plurality of small groups, but the sum of intimacies of the object in the small groups is less than an outcast determination threshold, the corresponding object may be determined to be an outcast.

The user interface unit 70 may adjust and display the distances between objects depending on the intimacies calculated by the intimacy prediction unit 40. Further, the user interface unit 70 may display the performance results of the small group configuration unit 50 and the outcast detection unit 60.

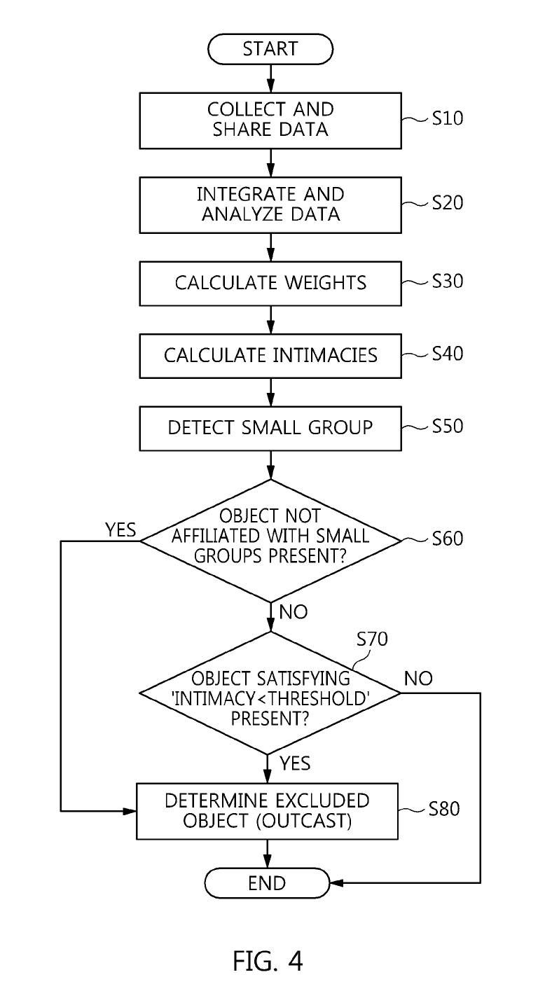

FIG. 4 is a flowchart showing a method for detecting a small group and an outcast according to an embodiment of the present invention.

First, the data collection unit 10 may directly monitor and collect interaction data (communication data, shared content data, explicit data, etc.) between communicable objects from the corresponding device, or may collect interaction data from portal sites or SNS sites to which each user has subscribed over the Internet at step S10. Of course, the interaction data collected in this way may be shared with other devices, and thus the data collection unit 10 may also receive interaction data collected from other devices.

Then, the data integration unit 20 integrates the collected data while eliminating duplicated data. Further, the data analysis unit 30 analyzes the integrated data, calculates weights depending on the densities of interactions, and standardizes the data if necessary at steps S20 and S30.

Thereafter, the intimacy prediction unit 40 calculates intimacies between objects using an intimacy model based on the analyzed data, wherein a linear model in which, as more common grounds are present and the number of interactions is larger between objects, intimacies become higher may be applied to the intimacy prediction unit at step S40.

Further, the small group configuration unit 50 detects one or more small groups from a certain group based on the calculated intimacies, wherein, as an intimacy between objects is higher, the objects may be configured as the same small group, and each object may be affiliated with one or more small groups depending on a configuration scheme, at step S50.

Thereafter, the outcast detection unit 60 determines whether there is an object that is not affiliated with any small groups at step S60.

If it is determined that an object that is not affiliated with any small groups is not present (No at step S60), that is, if all objects are affiliated with their own small groups, the outcast detection unit 60 determines whether the intimacy of each object is less than a preset outcast determination threshold for the corresponding small group at step S70.

If it is determined that the intimacy of the object is less than the outcast determination threshold for the corresponding small group (Yes at step S70), the outcast detection unit 60 determines the object to be an outcast in the affiliated small group at step S80.

In contrast, if it is determined at step S60 that an object that is not affiliated with any small groups is present, the outcast detection unit 60 determines the corresponding object to be an excluded object (outcast) at step S80.

Of course, when the object is affiliated with a plurality of small groups, but the sum of intimacies of the object in the small groups is less than a preset outcast determination threshold, the outcast detection unit 60 may determine the object to be an excluded object (outcast).

Further, the performance results of the small group configuration unit 50 and the outcast detection unit 60 may be transferred to and displayed on the user interface unit 70. For example, in the central management mode of FIG. 1, nearby objects (nodes) may be displayed on the user interface unit 70 based on location or, alternatively, objects (nodes) may be selected and displayed based on each affiliation type or each communication type, and nodes having intimacies of a predetermined value or more may be selected and displayed. In the distributed management mode FIG. 2, nearby objects may be detected, and the detected objects may be represented by nodes and displayed as the nodes on the user interface unit 70. A specific tag or an interaction type may be selected and analyzed, and then intimacies may be predicted. Depending on the predicted intimacies, distances between objects displayed on the user interface unit 70 may be determined. In addition, as an intimacy between objects is higher, a line connected to the objects may be indicated by a bolder line. Small groups detected based on intimacies may be displayed to be present within the same colored circle, or nodes (objects) in each small group may be represented by the same color. Meanwhile, outcasts may be separately represented by blinking objects, or marks such as circles or stars.

In accordance with the present invention having the above configuration, interactions occurring between devices and between users may be integrated or separated and analyzed, so that intimacies between objects are predicted, thus enabling small groups having a common ground to be detected from a certain group, and outcasts to be determined based on the small groups.

If a small group having a specific common ground is found, the provision of customized content conforming to the common ground is possible, so that a user may not be interfered with by undesired information, and a content provider may improve the efficiency and economic value of the overall information flow in such a way as to improve service quality and maximize advertising profits thanks to the provision of a customized service.

Furthermore, outcasts within a group such as a class or an office may be detected, and thus it is predicted that the present invention can solve social problems such as outcasting or suicide.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A system for detecting a small group and an outcast, comprising:
a data collection unit for collecting data based on interactions between objects;
a data analysis unit for analyzing the data;
an intimacy prediction unit for calculating intimacies between objects based on the analyzed data;
a small group configuration unit for detecting one or more small groups from a certain group, based on the calculated intimacies; and
an outcast detection unit for detecting an outcast, based on presence or absence of each object in the one or more small groups and the intimacies.

2. The system of claim 1, wherein the outcast detection unit determines an object that is not affiliated with any small groups to be an outcast.

3. The system of claim 1, wherein the outcast detection unit is configured such that, even if an object is affiliated with at least one small group, when an intimacy of the object is less than an outcast determination threshold for the affiliated small group, the object is determined to be an outcast in the affiliated small group.

4. The system of claim 1, wherein the outcast detection unit is configured such that, when an object is affiliated with a plurality of small groups, but a sum of intimacies of the object in the plurality of small groups is less than an outcast determination threshold, the object is determined to be an outcast.

5. The system of claim 1, wherein the intimacy prediction unit calculates the intimacies between objects based on the analyzed data by utilizing a linear model in which, as more common grounds are present and a number of interactions is larger between objects, intimacies become higher.

6. The system of claim 1, wherein the data analysis unit analyzes the data based on the interactions and then calculates weights.

7. The system of claim 1, wherein the data based on the interactions includes communication data, shared content data, and explicit data.

8. The system of claim 1, further comprising a user interface unit for displaying the objects and displaying performance results of the small group configuration unit and the outcast detection unit.

9. The system of claim 8, wherein the user interface unit represents the outcast by a blinking object or by a separate mark.

10. The system of claim 8, wherein the user interface unit determines distances between the objects depending on the intimacies calculated by the intimacy prediction unit, and displays the distances.

11. The system of claim 8, wherein the user interface unit is configured to, as an intimacy between the objects is higher, indicate a line connected to the objects by a bolder line.

12. A method for detecting a small group and an outcast, comprising:
collecting, by a data collection unit, data based on interactions between objects;
analyzing, by a data analysis unit, the data;
calculating, by an intimacy prediction unit, intimacies between objects based on the analyzed data;
detecting, by a small group configuration unit, one or more small groups from a certain group, based on the calculated intimacies; and
detecting, by an outcast detection unit, an outcast based on presence or absence of each object in the one or more small groups and the intimacies.

13. The method of claim 12, wherein detecting the outcast comprises determining an object that is not affiliated with any small groups to be an outcast.

14. The method of claim 12, wherein detecting the outcast comprises, even if an object is affiliated with at least one small group, when an intimacy of the object is less than an outcast determination threshold for the affiliated small group, determining the object to be an outcast in the affiliated small group.

15. The method of claim 12, wherein detecting the outcast comprises, when an object is affiliated with a plurality of small groups, but a sum of intimacies of the object in the plurality of small groups is less than an outcast determination threshold, determining the object to be an outcast.

16. The method of claim 12, wherein calculating the intimacies between the objects comprises calculating the intimacies between the objects based on the analyzed data by utilizing a linear model in which, as more common grounds are present and a number of interactions is larger between objects, intimacies become higher.

17. The method of claim 12, further comprising displaying, by a user interface unit, the objects, the one or more small groups, and the outcast.

18. The method of claim 17, wherein displaying the outcast comprises representing the outcast by a blinking object or by a separate mark.
